(19) United States
(12) Patent Application Publication
(10) Pub. No.: US 2022/0138812 A1
(43) Pub. Date: May 5, 2022

(54) METHOD AND SYSTEM FOR PROVIDING COMMUNITY SERVICE FOR EVENT PARTICIPANTS

(71) Applicant: PICKBANG INC., Seungnam-si (KR)

(72) Inventor: Hyo-Hwan BAE, Yongin-si (KR)

(73) Assignee: PICKBANG INC., Seungnam-si (KR)

(21) Appl. No.: 17/527,822

(22) Filed: Nov. 16, 2021

Related U.S. Application Data
(63) Continuation of application No. PCT/KR2020/006392, filed on May 15, 2020.

(30) Foreign Application Priority Data
May 16, 2019 (KR) 10-2019-0057325

(51) Int. Cl. G06Q 30/02; G06F 21/31; G06Q 50/10; G06Q 20/06

(52) U.S. Cl. CPC G06Q 30/0279; G06F 21/31; G06F 2221/2141; G06Q 50/10; G06Q 20/06; G06Q 30/0208

(57) ABSTRACT

Provided is a method and system for inducing to participate in an event. According to an embodiment of the present disclosure, the method performed by a computing device for providing a community service for an event participant comprises registering a user who enters an event venue where an event is in progress as a member of a community service that is generated only while the event is in progress, giving a mission set to a terminal of the user at a time the event is in progress, wherein a performance time of a mission included in the mission set is determined so that the mission set corresponds to a timeline of a content of the event, and determining whether an input time of sensing data measured by the terminal corresponds to the performance time of the mission to provide a reward corresponding to whether the mission is performed to an account of the user registered in the community service.

This application is a continuation application of PCT International Application No. PCT/KR2020/006392 filed May 15, 2020, which claims priority from Korean Patent Application No. 10-2019-0057325, filed on May 16, 2019 in the Korean Intellectual Property Office, the disclosures of which are incorporated herein in their entirety by reference.

### TECHNICAL FIELD

The present invention relates to a method and system for providing community service for event participants. More particularly, it relates to a method and system for inducing audiences to voluntarily participate in an event.

### BACKGROUND ART

Various means are mobilized, such as a large electronic display board, to induce audience participation in events such as singers' performances. However, since there is no technical means for objectively measuring the audience's participation, there is a limit in inducing the audience's participation.

However, a platform capable of inducing the participation of the audiences in the performance and providing appropriate reward in accordance with it while requiring minimal additional cost input for this purpose, and its basis system are not provided.

### DISCLOSURE

### Technical Problem

The technical object of the present disclosure is to provide a method and system for inducing audiences to voluntarily participate in an event.

Another technical object of the present disclosure is to provide a method and system for inducing participation in an event targeting only audiences by providing a closed community that can only be accessed by audiences located in an area corresponding to a specific space and providing a reward service.

Another technical object by the present disclosure is to provide a method and system for measuring the degree of participation in a performance using a sensor provided in a mobile terminal of an audience.

Another technical object of the present disclosure is to provide a method and system for minimizing additional cost input for inducing participation in a performance by automatically generating participation missions for a performance based on performance content.

The technical objects of the present disclosure are not limited to the technical objects mentioned above, and other technical objects not mentioned will be clearly understood by those skilled in the art from the following description.

### Technical Solution

According to an aspect of the inventive concept, there is provided a method performed by a computing device for providing a community service for an event participant comprising: registering a user who enters an event venue where an event is in progress as a member of a community service that is generated only while the event is in progress, giving a mission set to a terminal of the user at a time the event is in progress, wherein a performance time of a mission included in the mission set is determined so that the mission set corresponds to a timeline of a content of the event, and determining whether an input time of sensing data measured by the terminal corresponds to the performance time of the mission to provide a reward corresponding to whether the mission is performed to an account of the user registered in the community service.

The registering the user as a member of the community service may comprise registering the user as a member of the community service in response to the terminal recognizing an identifier of the event venue or registering the user as a member of the community service in response to a scanning device of the event venue recognizing an identifier of the terminal.

The registering the user as a member of the community service may comprise registering the user as any one member group among a plurality of member groups based on an area of the user provided in the event venue. The mission set may comprise a first mission set given to a first member group among the plurality of member groups, and a second mission set given to a second member group among the plurality of member groups, wherein a property of the first mission set is at least partially different from a property of the second mission set. And each of the plurality of member groups may be a group that is distinguished according to a right of users included in the group to use the community service.

The giving the mission set may comprise providing an alarm signal informing the terminal of the user on the performance time of the mission.

The providing the reward may comprise calculating a score corresponding to whether the mission is performed based on the sensing data, and determining the reward based on the score.

The method may further comprise inquiring a profile of an account of another user registered in the community service using the reward provided to the account or communicating with another user registered in the community service using the reward provided to the account.

### BRIEF DESCRIPTION OF THE DRAWINGS

FIGS. 1 to 2 are block diagrams of an event participation inducing system according to an embodiment of the present disclosure.

FIG. 3 is a flowchart of a method for inducing participation in an event according to another embodiment of the present disclosure.

FIG. 4 is a flowchart of a method of automatically registering as a member of a community service of an event venue through identifier recognition according to the method described with reference to FIG. 3.

FIG. 5 is a flowchart of a method, in which the user of the user terminal is automatically registered as a member of the community service of the event venue according to the method described with reference to FIG. 4.

FIGS. 6 to 7 are conceptual diagrams for further describing the step of automatically registering as a member of the community service according to the stored ticket contents according to the method described with reference to FIG. 5.

FIG. 8 is a flowchart of a method, in which sensing data is received while a mission is in progress according to the method described with reference to FIG. 3.

FIGS. 9 to 10 are exemplary views, in which the contents of the mission are displayed with reference to FIG. 8.

FIG. 11 is a flowchart illustrating a method for receiving sensing data according to the method described with reference to FIG. 8.

FIG. 12 is an exemplary view, in which whether the mission is performed is displayed on the electronic display board.

FIG. 13 is a flowchart of a method, in which a reward corresponding to whether a mission is performed is given to an account of a user of the user terminal according to the method described with reference to FIG. 3.

FIGS. 14 to 15 are exemplary views of a reward.

### DETAILED DESCRIPTION

Hereinafter, preferred embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

The term “comprises” and/or “comprising” used in the description means that one or more other components, steps, operation and/or existence or addition of elements are not excluded in addition to the described components, steps, operation and/or elements.

Hereinafter, some embodiments of the present invention will be described in detail with reference to the accompanying drawings.

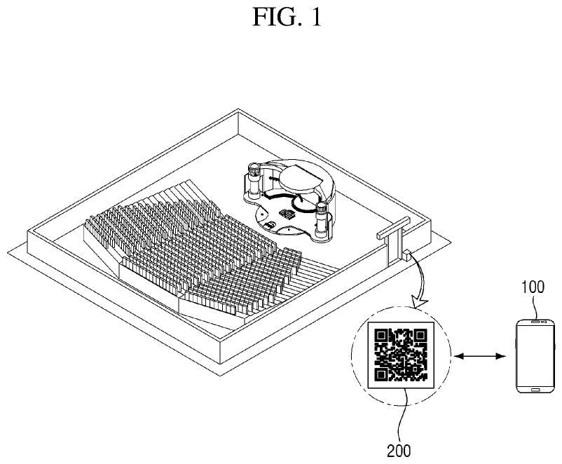

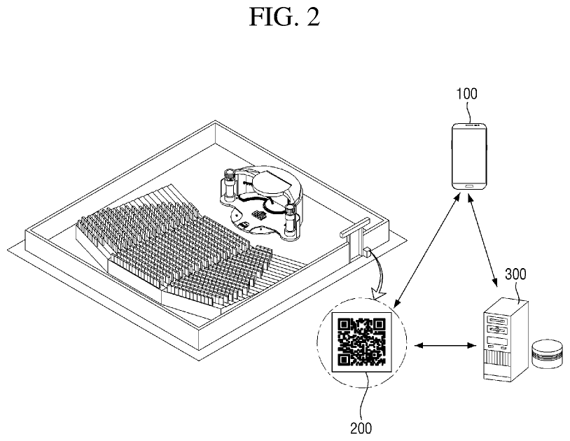

The configuration and operation of the event participation inducing system according to an embodiment of the present disclosure will be described with reference to FIGS. 1 to 2. The event participation inducing system according to the present embodiment may include one or more computing devices. However, this is only a preferred embodiment for achieving the object of the present disclosure, and some components may be added or deleted as needed. Hereinafter, each component will be briefly described.

First, according to the embodiment shown in FIG. 1, the user terminal 100 is illustrated. The user terminal 100 is a computing device used by a user who enters an event venue to watch a performance. The user terminal 100 may be a smart phone, a smart watch, etc., but is not limited thereto, and may include any device equipped with a calculation means and a communication means.

An application (APP) may be downloaded to the user terminal 100, and a community service may be provided through the APP. The APP refers to software that recognizes and decodes the identifier and automatically registers the user of the user terminal as a member of the community service using the decoded character.

The community service refers to a closed online service that can be automatically registered only through recognition of the identifier, and cannot be used outside the event venue because connection is blocked when going out of the event venue. Details are provided below.

The user terminal 100 may recognize the identifier 200 installed in the event venue when entering the event venue. For the recognition method, scanning or photographing of an identifier may be used, or an RFID tag method may be used.

The identifier contains specific information and refers to a mark for recognizing it. In FIG. 1, a QR code, which is a two-dimensional barcode, is shown as an example of the identifier 200. In addition to this, one-dimensional barcodes, other two-dimensional barcodes, or watermarks may all be included. Hereinafter, the QR code will be mainly described for convenience of understanding, but this may be applied to other identifiers 200.

When the identifier 200 is recognized by the user terminal 100, the user of the user terminal is automatically registered as a member of the community service of the event venue. Automatic registration will be described in detail below with reference to FIG. 2.

The community service is a service that can maximize the fun of a performance by allowing users gathered in a specific space at a specific time to perform a mission together or to communicate with each other. Accordingly, in the community service, one service may be provided in one space, or different communities may be provided according to classification conditions.

Also, the community service may be a service for terminating service provision according to the termination of the event venue. That is, the community service may be a one-time community service that is generated only while the event at the event venue is in progress.

In addition, the community service may be a service, in which the user of the user terminal 100 is automatically removed from a member of the community service when the position information of the user terminal 100 deviates from the corresponding area of the event venue.

The user terminal 100 may include a sensor for recognizing the user's motion. By using the sensing data generated through the sensor, it may be determined whether the mission given to the audience of the event venue is performed. In addition, a reward corresponding to whether the mission is performed may be given to the user's account.

A user input may be detected to determine whether the mission is performed. The user input may be input to the user terminal 100 through a pointing-capable input device provided in the user terminal 100. The pointing-capable input device may be, for example, a touchpad, a touch display, a mouse, a stylus pen, or a pupil position tracking device.

In response to the user input, the user terminal 100 may directly determine whether or not the mission is performed, or transmit data on whether the mission is performed to the server 300. This will be described with reference to FIG. 2.

Referring to FIG. 2, the event participation inducing system according to the present embodiment may further include one or more servers 300. The server may be a laptop computer, a desktop, or the like, but may be preferably implemented as a high-performance server computing device. However, the present disclosure is not limited thereto, and the server 300 may include any device equipped with a calculation means and a communication means.

The server 300 may control the identifier 200 to be displayed through an electronic display board located at the event venue, and when the identifier 200 is recognized by the user terminal 100, the user of the user terminal 100 may be automatically registered as a member of the community service of the event venue.

For example, when the user terminal recognizes a QR code that is an identifier, a specific character string can be obtained. The corresponding character string may be a link path for providing a specific service in the user terminal. For example, the character string may be a command for automatically transmitting a text message (SMS) of a specific content to a specific user. Alternatively, it may be a command for changing a specific setting of the user terminal. For example, it may be a command for turning on Wi-Fi and automatically inputting a specific password to Wi-Fi of a specific SSID to connect it.

At this time, even when the same first QR code is photographed, the first user terminal may be connected to the first specific path, and another second user terminal may be connected to the second specific path. In other words, it is possible to provide various services with one QR code.

In this way, in order to provide various services with one QR code, information additionally generated while photographing the QR code may be used. That is, in addition to the image generated by photographing the QR code, it is possible to use meta data about the image.

Among the meta information about the image, information on 1) the time, at which the image was photographed, 2) the position where the image was photographed (GPS information), and 3) the device, in which the image was photographed, may be additionally used. That is, even with the same QR code, if the photographed time is different, the photographed position is different, or the photographing device is different, a link can be dynamically generated and provided so that links that provide different services are connected. Through this, it is possible to provide a service specialized for a specific time, a specific position, or a specific user with a single QR code. Of course, information about the time, at which the image was photographed, the position where the image was photographed, and the device, in which the image was photographed, may be collected in other ways than meta information of the image.

Recently, in a wireless mobile communication terminal such as a smartphone, even if the QR code is not photographed, simply by locating the QR code in a specific area of the screen through the camera application, the QR code is automatically scanned and a character string is generated. Since no image is photographed in this process, in this case, the time information when the QR code is scanned to generate a character string, the position information of the wireless mobile communication terminal at that time, and the information of the wireless mobile communication terminal at that time may be used to generate a dynamic URL. A community service is provided through the generated dynamic URL, and at this time, a user of the user terminal that has recognized the identifier may be automatically registered as a member in the community service and provided with the service. In addition, since the URL becomes invalid after member registration, other people cannot connect the URL, thereby providing a closed service.

In addition, when the user of the user terminal 100 is automatically registered as a member of the community service of the event venue through recognition of the identifier 200, the identifier may be automatically changed to another one.

The server 300 may receive the sensing data of the user terminal 100 and determine whether the mission of the user terminal 100 is performed through the received sensing data. In addition, a reward according to whether the mission is performed may be determined, and the determined reward may be given to the user's account of the user terminal 100.

In this case, the account of the user, to which the reward is given, may be an account used only in the community service, or may be an account independent of the community service. For example, it may be a cryptocurrency wallet. When a reward is given to an account used only in the community service, since the community service disappears with the termination of the event, the user is able to use the reward only during the event. On the other hand, if a reward is given to an account independent of the community service, the user is able to use the reward even after the event is terminated.

When the reward is given in the form of cryptocurrency, in some embodiments, information indicating that the cryptocurrency acquired by the user was acquired as a reward may be included in the transaction data indicating the transfer of the cryptocurrency. That is, in the block chain, in which the transaction details of the cryptocurrency are recorded, the performance participation reward may be recorded as the reason for the transaction of the cryptocurrency. Of course, as additional information of the performance participation reward, performance identification information for accessing detailed information of the performance may be included.

When the reward is given in the form of cryptocurrency, the fact that the cryptocurrency was acquired as the performance participation reward may be recorded in the cryptocurrency data. That is, a value indicating the performance participation reward may be set as a value of a field indicating the reason for acquiring cryptocurrency. In this case, of course, as additional information of the performance participation reward, performance identification information for accessing detailed information of the performance may be included.

If the reward is given in cryptocurrency, the transaction can be performed using the cryptocurrency received as a reward for participating in the performance However, by providing goods or services that can only be purchased with cryptocurrency obtained as a reward for participating in a performance according to the above-described embodiment, it will be possible to induce a stronger response from the audience. For example, if limited edition idol goods that can only be purchased with cryptocurrency acquired as a reward for participating in a performance are sold, fans of the idol will be able to enthusiastically participate in the idol's performance and purchase limited edition goods using the cryptocurrency acquired as a reward.

That is, even if the cryptocurrency acquired by the audience as a performance participation reward is a general-purpose cryptocurrency with various other uses, according to this embodiment, it can be identified that the cryptocurrency was acquired as a performance participation reward, and thereby it will be possible to sell differentiated products or provide differentiated services to audiences who own the general-purpose cryptocurrency, which was acquired as a performance participation reward. In this way, the audience will participate more enthusiastically in the performance.

Hereinafter, a method for inducing participation in an event according to another embodiment of the present disclosure will be described.

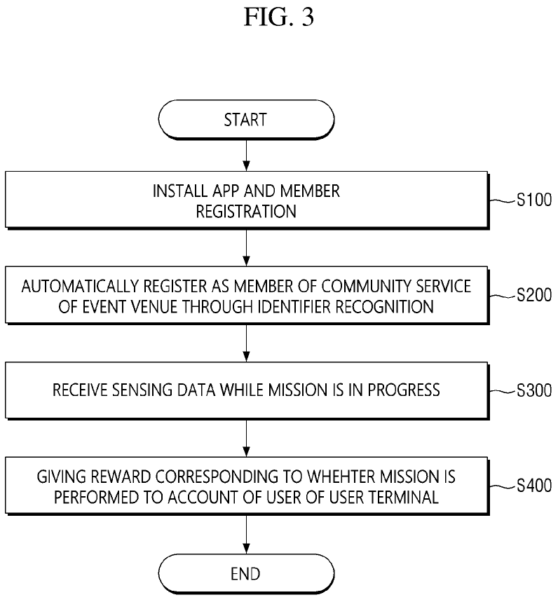

FIG. 3 is a flowchart of the present embodiment. This embodiment may be generally understood as a method for the user terminal to recognize the identifier, automatically register the user of the user terminal as a member of the community service, and efficiently induce participation in the event using the community service.

In addition, the method according to the present embodiment is performed by a computing device, and all the operations included in the method of the present embodiment may be executed by physically one computing device. However, the first operations of the method of the present embodiment may be performed by the first computing device, and the second operations of the method of the present embodiment may be performed by the second computing device. Hereinafter, each operation of the present embodiment will be described. When the subject of each operation is omitted, the subject may be the computer device.

Referring to FIG. 3, in step S100, APP installation and membership registration through the installed APP may be performed. In the case of a user terminal, in which APP installation and membership registration have already been performed, step S100 may be omitted.

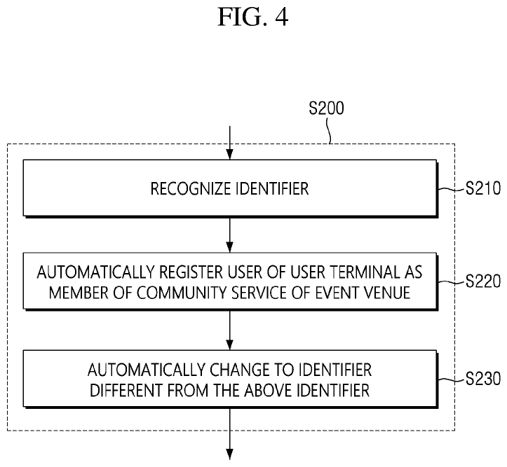

In step S200, the user of the user terminal is automatically registered as a member of the community service of the event venue through identifier recognition. It will be described in detail with reference to FIG. 4.

In step S210, the identifier may be recognized. For recognition of the identifier, an identifier (QR code, etc.) displayed in the event venue may be recognized through a sensor provided in the user terminal 100. Alternatively, the identifier may be displayed on the user terminal, and the displayed identifier may be recognized through a recognizing device (e.g. reader) installed in the event venue. The recognizing device may include a fixed type installed at a specific position in the event venue, and a mobile type carried by a facilitator who conducts the event.

In step S220, the user of the user terminal may be automatically registered as a member of the community service of the event venue. The automatic registration means that the user is automatically registered as a member of the community only by recognizing the identifier displayed at the event venue without a separate operation of the user terminal and a prior procedure for joining the community of the participating event. And, it may be understood that the community allows member registration only when there is recognition of the identifier.

In some embodiments, when automatically registering as a member of the community service, mission set data may be downloaded. The mission set data means data on the timing of occurrence based on the event timeline of a plurality of missions and data on the type of each mission. In this way, by downloading the mission set data to the user terminal in advance, the user terminal can provide a mission without exchanging information with the server. That is, there is an effect of solving a traffic problem that may occur when a large number of people gather at the event venue.

In some embodiments, the mission set data may be downloaded according to the number of user terminals automatically registered as a member of the community service. That is, when the number of people is less than or equal to the designated number of people, the mission is provided through the server, and when the number of people is greater than or equal to the designated number, the mission set data is used, so that the traffic problem can be flexibly dealt.

In addition, when the automatic registration is performed, the user may be automatically registered in different communities according to classification conditions.

In some embodiments, the number of community users may be used as the classification condition. If the number of currently connected users of the community is received through the identifier, and the number of currently automatically registered users of the first community is the same as the preset number of users using the received number of users, it can be automatically registered in the second community through the identifier.

By using the number of users as a classification condition, there will be an effect of tying members of one community service into one team and performing a team mission, in which each team is rewarded according to the mission performance

In some embodiments, the recognition time of the identifier may be a criterion for the classification condition. That is, depending on the recognition time of the identifier, it can be automatically registered in different community services even within one event.

In some embodiments, it may be automatically registered in the community service according to the time of recognizing the identifier or the time at which the identifier is recognized. Specifically, different codes may be allocated according to time zones, and a community service corresponding to the codes may be automatically registered. As communities are divided according to the number of users, there is an effect that users having similar recognition time zones can use the same community service.

For example, an identifier may be displayed at the entrance of an event venue such as a club, and the identifier may be recognized while an audience enters. Then, it is possible to provide a service only for the audiences who enter the same club at the same time zone.

In some embodiments, it is possible to receive user information of the user terminal, calculate a weight for each of the user information, give the usage level, and automatically register in a community service corresponding to the given usage level. The user information may mean information of a user of a user terminal. For example, gender, age, type of ticket (VIP), etc. may be included.

Different services may be provided for each community service classified according to the level. For example, in the first community, a user of the first community can inquire about other users of the first community and can communicate with other users, and in the second community, a user of the second community can inquire about other users of the second community, but cannot communicate with other users. In this case, the second community may be one, in which the user of the second community can transfer to the first community by invitation of the user of the first community.

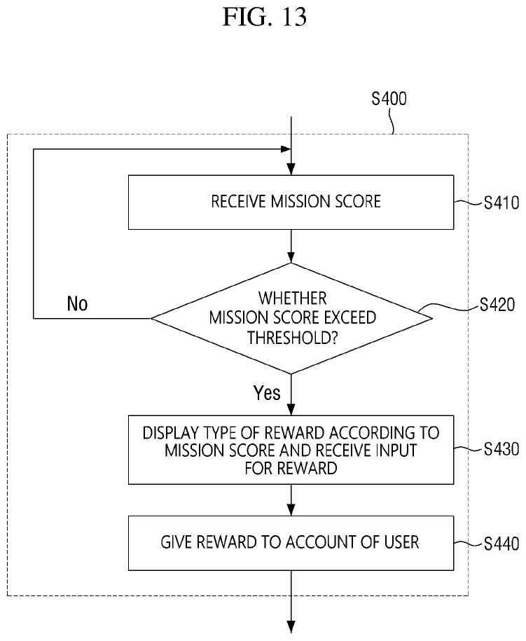

In some embodiments, the level may be changed according to whether the user performs a mission or the like. This will be described with reference to FIGS. 13 to 17.

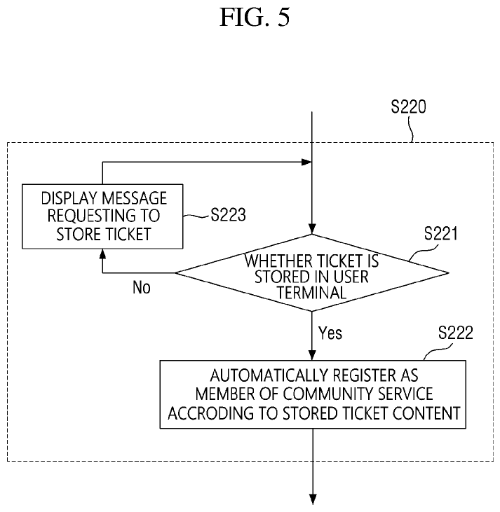

In some embodiments, the ticket content of the event venue may be a classification condition. In this case, a ticket to the event venue may be requested as a condition for automatically joining as a community member. Hereinafter, it will be described with reference to FIG. 5.

In step S221, it may be determined whether the event ticket is stored in the user terminal. The ticket may be a ticket stored in the storage device of the user terminal, or may be an electronic ticket stored through the APP downloaded to the user terminal described in FIG. 1.

When the event ticket is not stored in the user terminal, a message requesting to store the event ticket may be displayed in step S223. Conversely, when the event ticket is stored in the user terminal, the user may be automatically registered as a member of the community service according to the stored ticket contents in step S222. By automatically registering as a member of the community service only when the ticket is stored, there is an effect of preventing a person who is not an audience of the event venue from being registered in the community through recognition of the identifier.

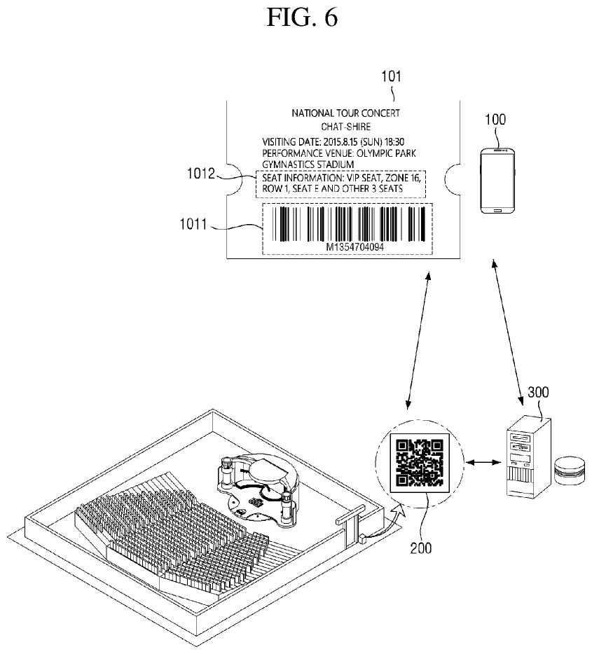

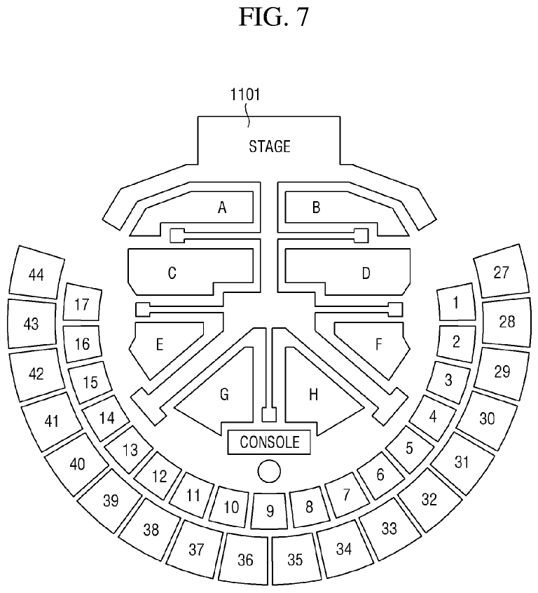

Step S222 will be described in detail with reference to FIGS. 6 to 7.

FIG. 6 is a block diagram of a system for performing the method of FIG. 5. Since each configuration has been described with reference to FIGS. 1 and 2, a description of overlapping parts is omitted. Here, only the part performing the method of FIG. 5 will be described.

Referring to FIG. 6, the identifier 200 displayed in the event venue is recognized through a sensor attached to the user terminal 100. When the identifier 200 is recognized, the server 300 determines whether the ticket 101 of the event venue is stored in the user terminal 100. The server 300 may automatically register the user of the user terminal 100 as a member of the community service of the event venue only when the ticket 101 of the event venue is stored in the user terminal 100.

In addition, when the identifier 200 displayed in the event venue is recognized through a sensor attached to the user terminal, the ticket 101 stored in the user terminal may be displayed on the screen of the user terminal. There is an effect that the inconvenience of the audience having to operate to display the ticket 101 is reduced.

FIG. 6 shows a barcode 1011 on a ticket 101 as an example of an identifier. In addition to this, other one-dimensional barcodes or two-dimensional barcodes (e.g., QR codes) or watermarks may all be included. Hereinafter, the description will be focused on barcodes for convenience of understanding, but this may be applied to other identifiers.

The barcode 1011 displayed on the ticket 101 may be used to determine the user's level of the user terminal 100 and the user's community service when automatically registering in the community service.

In some embodiments, the user's level and the user's community service may be determined based on the seat information 1012 of the ticket 101. That is, a community service composed only of users in the same or adjacent seating zones may be provided. Specifically, if the zone described in the seat information 1012, in which the seat is located, is the first zone, it may be automatically registered in the first community, and if it is the second zone, it may be automatically registered in the second community. It will be further described with reference to FIG. 7.

As shown in FIG. 7, the structure of the event venue may be divided into zones marked with eight alphabets and zones marked with numbers around a stage 1101.

For each zone, a user of a user terminal storing a ticket for zone A may be automatically registered in the first community service, and a user of a user terminal storing a ticket for zone B may be automatically registered in the second community service.

Alternatively, the user of the seat corresponding to the zone indicated by the alphabet may be automatically registered in a community service of a higher level than the user of the seat corresponding to the zone indicated by the number.

The automatic registration for each zone has the effect of performing different missions for each zone. In particular, in the case of an event, in which several performers (e.g., singers) appear, a viewing zone for each performer's supporters may be designated. In this case, different community services may be provided to supporters divided by each zone, and different missions may be provided to supporters using the different community services.

For example, supporters of singer A may have designated zone A as a viewing zone. It is assumed that the user of the user terminal having a seat in zone A is automatically registered as a member of the first community. In this case, during the performance of singer A, only the members automatically registered in the first community service may be given the card section mission, and the members automatically registered in other community services may be given the applause mission. Alternatively, through the different missions, a dynamic mission may be performed for a performance of a performer supported by themselves, and a mission that consumes less stamina may be performed for a performance of another performer. In other words, since the user can concentrate on the performance of the performer he or she supports, it is able to induce participation in the event more effectively.

Referring back to FIG. 4, in step S230, the identifier may be automatically changed to an identifier different from the identifier. Through the change of the identifier, each user terminal will be automatically registered through a unique identifier. By giving different identifiers to each user terminal, there is an effect of grouping a plurality of user terminals to facilitate management. In addition, there is an effect of preventing a person who is not a participant of the event venue from being registered in the community through a copy of the identifier.

Referring back to FIG. 3, in step S300, sensing data is received while the mission is in progress.

In this disclosure, a mission includes anything having performance characteristics, in which the boundary between the subject (producer) and the object (consumer), or between the performer and the audience in a performance is broken. In other words, it can include anything that induces the audience to take a specific action in accordance with the content of the event. For example, the mission may be to jump to the climax of the music. Alternatively, the mission may be to touch to the device with a concept similar to applause. In addition to this, it may be to run the APP at a specific timing to perform the card section.

Specifically, in an event such as a rock festival, a mission of jumping according to the moment when the climax of the music is transmitted may be given. Alternatively, a mission to hold the screen of the user terminal toward the stage and wave a hand in the chorus portion may be given. In this case, the card section mission may be given using the screen of the user terminal. By displaying a different color or shape for each seat of each audience, a card section may be formed as a whole. Furthermore, the entire image may be displayed on the electronic display board of the event venue so that the audience can see this image.

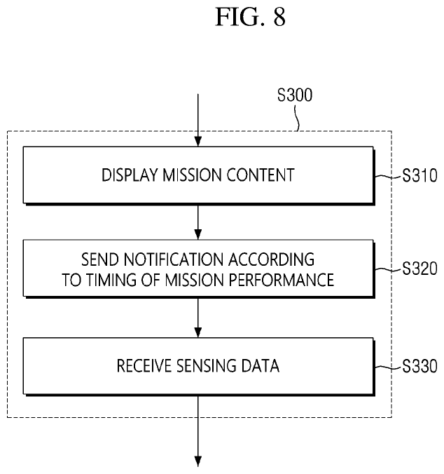

The mission may be given as a predefined one to be performed at a specific timing of the performance, or may be dynamically generated and given based on the performance content. In a case of a dynamically generated mission, there is an effect of inducing participants to participate in the performance in a lively manner It will be described in detail with reference to FIG. 8.

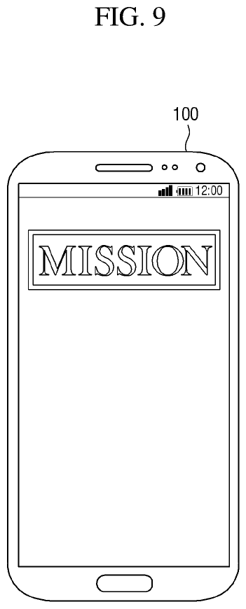

In step S310, the mission contents are displayed. The mission contents may be displayed through the display unit of the user terminal as shown in FIG. 9.

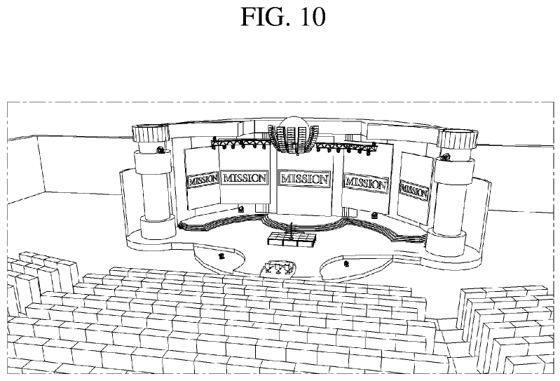

In some embodiments, the mission contents may be displayed through an electric display board installed in the event venue. FIG. 10 is an exemplary view, in which mission contents are displayed through an electric display board installed on the stage of the event venue.

In some embodiments, mission set data preset according to the type of event may be received, and the contents of the mission according to the received data may be displayed. The mission set data includes data on the timing of occurrence based on the event timeline of a plurality of missions and data on the type of each mission. For example, a mission set in case the performance is an EDM festival, a mission set used in a hip-hop club, and a mission set used in a professional sports event may be received and displayed.

In some embodiments, missions may be dynamically generated based on the content of the event. For example, using a specific bit of music being transmitted in the event venue, a mission may be dynamically generated according to the bit. In this case, if the bit is maintained for a predetermined time, the mission of performing the same operation may be repeatedly generated. For example, if a bit suitable for JUMP is maintained for more than a predetermined time, a repeating JUMP mission may be automatically generated.

Alternatively, a mission may be automatically generated by using the frequency data of the music being transmitted in the event venue when the frequency data is similar to the frequency of brain waves in a person's excited state. In this case, since the frequency of the participant's brain waves is used, there is an effect of inducing the participant's excitement.

Referring back to FIG. 8, in step S320, a notification according to a mission performance timing may be transmitted. For example, when a mission needs to jump according to a specific bit, a notification may be displayed on the screen according to the jump timing. Alternatively, a notification event that causes a sound or vibration of the user terminal may be generated. When the mission is to touch the user terminal according to a specific beat, the mission may be displayed or a notification event may be generated according to the touch moment. Through the above notification, it can have an effect that the participant actively participates in the event by performing the mission at the accurate timing needed to perform the mission.

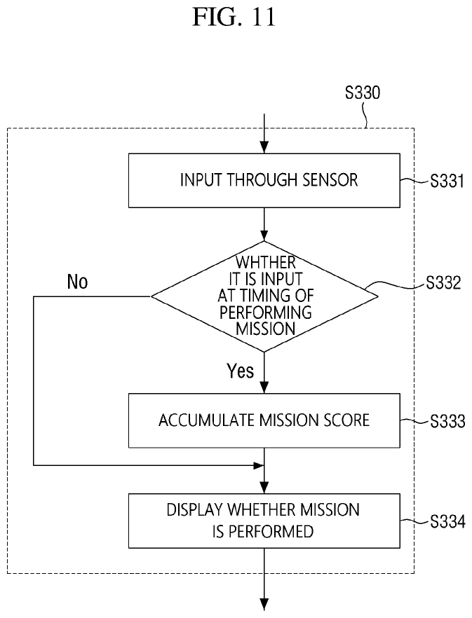

In step S330, sensing data is received. The sensing data means all data measured by a sensor of a user terminal. It will be described in detail with reference to FIG. 11.

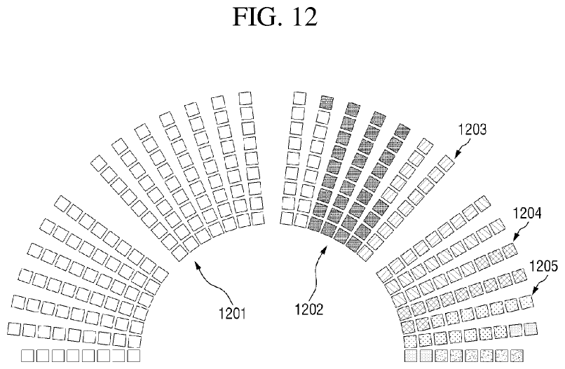

In step S331, an input through a sensor of the user terminal is received. In step S332, it is determined whether the input is an input at the timing of performing the mission. In the case of input at the timing of mission performance, mission scores are accumulated in step S333. Conversely, if it is not an input at the timing of mission performance, mission scores are not accumulated and step S334 is performed. In step S334, whether the mission is performed is displayed. At this time, whether the mission is performed may be transmitted to the server. Whether each of the participants is performed a mission may be received through the server, and the received mission performance result may be displayed in real time through an electronic display board installed on a stage of the event venue, etc. This will be described with reference to FIG. 12.

FIG. 12 is a diagram showing the current mission participation for each zone. The mission participation may be displayed differently according to the degree of mission participation. For example, it may be displayed in different colors depending on the degree of mission performance Referring to FIG. 12, an example, in which the audience 1201 who has not yet participated in the mission, the audience 1202 who has performed all missions, the audience 1203 who has performed 10% or less of the mission, the audience 1204 who has performed 10% or more, and 50% or less of the mission, and the audience 1205 who has performed 50% or more of the mission are classified and displayed, is shown. When the mission participation is displayed on the electronic display board, the audience can identify whether or not the mission has been performed by himself/herself at a glance, thereby increasing the audience's desire to participate in the event.

A total score may be displayed on a screen in some embodiments. When the total score displayed on the screen exceeds the threshold, all user terminals registered in the community may receive a reward. In this case, since everyone can receive a reward according to the mission, there is an effect of motivating each other to perform the mission.

Referring back to FIG. 3, in step S400, a reward corresponding to whether the mission is performed is given to the user's account of the user terminal. The reward includes everything provided in various ways such as cash, coupons, points, gift certificates, as well as cryptocurrency. The account may be an account used only in the community service, or may be an account independent of the community service.

When a reward is given to an account used only in the community service, the community service disappears with the termination of the event, so the user is able to use the reward only during the event. On the other hand, when a reward is given to an account independent of the community service, the user is able to use the reward even after the event is terminated. It will be described in detail with reference to FIG. 13.

In step S410, a mission score is received. In step S420, it is determined whether the mission score exceeds a threshold. When the mission score exceeds the threshold, in step S430, a type of reward according to the mission score is displayed and an input for selecting one of the displayed rewards is received. Conversely, when the mission score does not exceed the threshold, the flow returns to step S410 again, and the mission score is received. In step S440, the reward is given to the user's account.

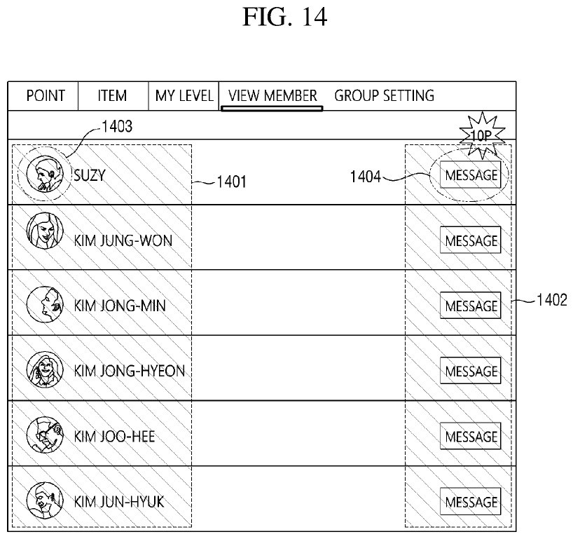

According to some embodiments, the user of the user terminal may communicate with other users registered in the community service by using the reward. At this time, the user who is the target of the profile inquiry or the message recipient may acquire the above reward. Of course, the more information a user upload to a profile, the more rewards a user can acquire. It will be described in detail with reference to FIG. 14.

As shown in FIG. 14, a member view function is provided through a community service. A user may inquire about a profile of a user of another user terminal registered as a member of the community service or send a message. For example, when an area 1401, in which a photo indicating a specific member is displayed, is clicked, a screen indicating a user profile of the clicked area may be displayed. If a user wants to send a message to a specific member, a message window may be displayed when the user clicks the send button 1402 located on the right side. If a user want to inquire about the profile of the user named Suzy from the list shown in FIG. 14, when the area 1403 where the picture of Suzy is displayed is clicked, a screen displaying the profile of Suzy is displayed. Alternatively, a message can be sent to Suzy by clicking the message button 1404 on the right side of the Suzy list.

The pass to use the profile view function or the message sending function may be differentially provided according to a user level. If the pass is not provided because the level is low or the provided pass is used up, the user may perform a new mission and purchase a pass through a reward provided according to the performance of the mission. Alternatively, a pass may be purchased using items sold separately.

According to some embodiments, the user level may be changed according to the reward. For example, if the current level of the user is level 4, the user is automatically registered in the level 4 community service at this time. It is assumed that the user's current points are 185 points and 15 more points are needed to level up. In this case, if the user acquires 15 more points through mission performance, etc., he/she may be automatically registered in a level 5 community. If the level is changed to level 5 by acquiring 15 more points, all previously accumulated points are reset, and it may be necessary to collect points again from the beginning.

In some embodiments, different benefits may be provided depending on the level. For example, in the case of a high level, a ceremony may be displayed on an electronic display board upon entry, a designated song may be played, or a security officer may be provided.

In some embodiments, the right to pre-book other performances may be given according to the level. For example, when a reservation for a performance starts, a reservation button may be activated from a user terminal with a high level. That is, the right to participate in the performance is first given to a high-level user through the differential reservation right according to the level, and the high-level user can preempt a desired seat. In addition, re-participation of high-participation members can be secured by activating reservations according to the levels acquired through participation. The re-participation rate of these high-level members may lead to higher participation in the next performance

In some embodiments, the rewards may be used for purchases of food and beverages or goods inside the event venue.

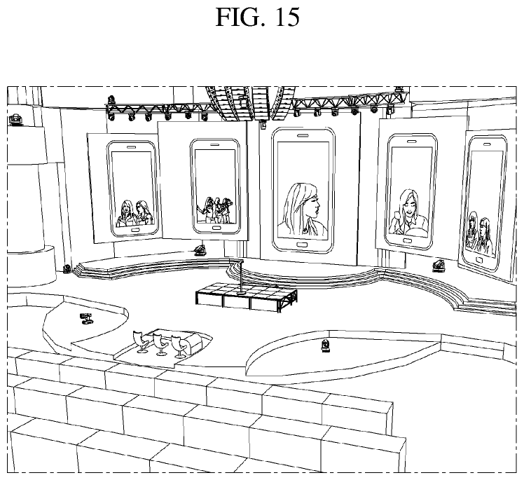

According to some embodiments, a song request may be proposed using the reward, or if the given reward exceeds a threshold, it may be exchanged with an item that can select content to be displayed through a screen located in the corresponding area of the event venue. In this case, the screen located in the corresponding area of the event venue may be controlled by the user terminal. In other words, the mission score is not just a score, but it can also be given the right to use the infrastructure of the event venue. Through this effect, the purpose of the present disclosure, inducing participation in a performance, may be maximized It will be described with reference to FIG. 15.

FIG. 15 is a diagram illustrating an example of selecting content to be displayed through a screen installed on the stage of the event venue using the reward. On each of the five screens shown, the screen of the user terminal is displayed. That is, through the reward, the right to the stage of the event venue can be given to the user who has successfully performed the mission.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

In the above, even though all the components constituting the embodiment of the present invention are described as being combined or operated in combination, the present invention is not necessarily limited to this embodiment. That is, within the scope of the object of the present invention, all the components may operate by selectively combining one or more.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method performed by a computing device for providing a community service for an event participant comprising:
registering a user who enters an event venue where an event is in progress as a member of a community service that is generated only while the event is in progress;
giving a mission set to a terminal of the user at a time the event is in progress, wherein a performance time of a mission included in the mission set is determined so that the mission set corresponds to a timeline of a content of the event; and
determining whether an input time of sensing data measured by the terminal corresponds to the performance time of the mission to provide a reward corresponding to whether the mission is performed to an account of the user registered in the community service.

2. The method of claim 1, wherein registering the user as a member of the community service comprises,
registering the user as a member of the community service in response to the terminal recognizing an identifier of the event venue.

3. The method of claim 1, wherein registering the user as a member of the community service comprises,
registering the user as a member of the community service in response to a scanning device of the event venue recognizing an identifier of the terminal.

4. The method of claim 1, wherein registering the user as a member of the community service comprises,
registering the user as any one member group among a plurality of member groups based on an area of the user provided in the event venue.

5. The method of claim 4, wherein the mission set comprises,
a first mission set given to a first member group among the plurality of member groups; and
a second mission set given to a second member group among the plurality of member groups,
wherein a property of the first mission set is at least partially different from a property of the second mission set.

6. The method of claim 4, wherein each of the plurality of member groups is a group that is distinguished according to a right of users included in the group to use the community service.

7. The method of claim 1, wherein giving the mission set comprises,
providing an alarm signal informing the terminal of the user on the performance time of the mission.

8. The method of claim 1, wherein providing the reward comprises,
calculating a score corresponding to whether the mission is performed based on the sensing data; and
determining the reward based on the score.

9. The method of claim 1 further comprises,
inquiring a profile of an account of another user registered in the community service using the reward provided to the account.

10. The method of claim 1 further comprises,
communicating with another user registered in the community service using the reward provided to the account.

11. The method of claim 1, wherein the mission comprises a first mission and a second mission,
wherein the first mission is a mission given while a performance is in progress, and the second mission is a mission given while the performance is in progress and is a mission given after the first mission is given according to a time sequence of the performance

12. The method of claim 1, wherein the community service of the event venue is a closed online service that can be automatically registered only through recognition of the identifier,
wherein the mission is given only during the time when a performance is in progress, and is given to all the audience without a consent of the audience who entered the event venue by a subject who planned the performance

13. The method of claim 1, wherein registering the user as a member of the community service comprises,
registering as a member of the community service only when a ticket for the event venue is stored in the user terminal.

14. The method of claim 1, wherein providing the reward comprises,
recognizing, by the terminal, a specific bit of music being transmitted to the event venue and determining whether a dynamic generation mission is performed according to the bit.

15. The method of claim 14, wherein determining whether a dynamical generation mission is performed according to the bit comprises,
automatically generating the dynamic generation mission indicating that the same operation is repeatedly performed when the specific bit is maintained for a predetermined time or longer.

16. The method of claim 1, wherein registering the user as a member of the community service comprises,
registering the user as a member of any one of a first community or a second community according to a level of the user,
wherein, in the first community, a user of the first community is able to inquire another user of the first community, and is able to communicate with another user,
wherein, in the second community, a user of the second community is able to inquire another user in the second community, but is not able to communicate with another user.

17. The method of claim 16, wherein registering the user as a member of the community service comprises,
transferring and registering a user of the second community to the first community in accordance with an invitation of a user of the first community.

18. The method of claim 1 further comprises,
supporting profile inquiry of another user registered in the community service using a reward provided to the account.

19. The method of claim 1 further comprises,
supporting communication with another user registered in the community service using a reward provided to the account.

20. The method of claim 1 further comprises,
supporting acquisition of an item capable of selecting a content displayed through a screen located in a corresponding area of the event venue using a reward provided to the account.
